(19) United States
(12) Patent Application Publication
(10) Pub. No.: US 2011/0037602 A1
(43) Pub. Date: Feb. 17, 2011

(54) Method and apparatus for protecting energy generation facility from dangerous degree of tilt

(76) Inventors: Wojciech Marek Chrosny, Orange, CT (US); Michael Charles Overturf, Washington, DC (US); Robert J. Applegate, Wallingford, CT (US); Richard G. Stine, Trumbull, CT (US); William D. Taylor, New Milford, CT (US)

Correspondence Address: Wojciech Marek Chrosny, 420 Yellow Brick Road, Orange, CT, 06477, US

(21) Appl. No.: 12/852,466

(22) Filed: Aug. 7, 2010

Related U.S. Application Data
(60) Provisional application No. 61/233,486, filed on Aug. 12, 2009.

(51) Int. Cl. G08B 21/02; H01H 35/02

(52) U.S. Cl. 340/635; 200/61.52

(57) ABSTRACT

A tilt protection apparatus applied to electric energy generating installations, where possibility of tilting or tipping over exists. In certain installations of electric energy generating facilities, the means of energy production, such as but not limited to solar photovoltaic panels, must be mounted on support system that can be susceptible to mechanical failure due to impact, wind induced vibration, ground vibration or ground displacement. In the event of the structural tilt, the apparatus detects such condition and disconnects the means of energy generation minimizing possibility of exposure to dangerous levels of electric potential.

This application refers to provisional application No. 61/233,486 with the same title and inventors.

### BACKGROUND OF THE INVENTION

The present invention relates to an improved energy generation installation and more particularly to an energy generation installation that is subject to tilting of tipping over. The energy generation facility may include but is not limited to photovoltaic panels mounted on a structure that could tilt or tip over due to impact, wind induced vibration, ground vibration or ground displacement. The use of photovoltaic and wind turbines and other means of energy generation in distributed generation applications are proliferating. As new methods of installation of such facilities expand to include raised structures of various kinds, it is important to provide safe ways of disconnecting energy generation to minimize possibility of exposing personnel to dangerous voltage potentials. The use of different tilt switches is well represented in prior art for protection of devices that use energy and can be dangerous if tipped over, such as electric heaters for example as described in U.S. Pat. No. 6,430,366. This invention presents a new method for disconnecting the energy-generating source from the rest of the energy transmission and energy conversion and builds on energy storage and retrieval concepts as described in U.S. Pat. No. 6,707,187. This invention in particular improves upon the existing practices of using Ground Fault Protection Devices. The Ground Fault Protection Devices interrupt the flow of excessive ground currents, protecting against fire hazards resulting accidental ground faults. Some energy generation systems continue to generate electrical energy even when Ground Fault Protection Device has disconnected the grounding circuit, in particular photovoltaic systems or mast mounted wind turbines may continue to generate electrical energy when the ground fault condition exist. The disconnection of the ground circuit reduces chances of fire caused by excessive current flowing through the grounded circuit, but it does not reduce potential for exposure to dangerous levels of electric potential and current from other parts of the system that continue to be energized. In installations such as photovoltaic or wind-turbine installation, the energy generation process continues even if the supporting structure tilts and the only means of stopping the generation would be to block the incident light in case of the photovoltaic system or in case of the wind turbine to physically stop from turning the generator. This invention describes a method and apparatus to disconnect the means of energy generation closer at their source, thus reducing the risk of exposure to the electrical potential. This invention also minimizes the number of elements of the system and its supporting structure that risk being energized during tilt or tip-over event.

### SUMMARY OF THE INVENTION

The present invention provides for detection of dangerous level of tilt or tip-over conditions of structures supporting energy generation means and disconnection of energy generation means. When a structure supporting the energy generation means, such as photovoltaic or wind turbine or other forms of energy generation, becomes tilted the components and circuitry described herein disconnect the energy generation components as close to the energy generation component as possible, reducing the danger of exposure to hazardous electrical potential.

This invention describes an additional safety measure for installations of energy generating means on raised structures. The current requirements and practice of using Ground Fault Protection Devices is adequate for installations where risk of tip-over is negligible. According to current UL 1741 Standard commercial Inverters must integrate the Ground Fault Protection capability. The Ground Fault Protection Devices are effective at detecting wiring faults during installation of the energy generation system. The risk of ground fault is usually the highest during system installation due to wiring mistakes. During normal system operation the risk of ground fault is much less likely, although may still occur due to mechanical abrasion, weather or rodent damage. The Ground Fault Protection device disconnects the grounding loop, reducing risk of fire due to excessive ground current. In effect when the Ground Fault protection disconnects the grounding loop the energy generation means continue to supply the electrical potential to the input of the Inverter, that simply stops converting the DC input current into AC output current and indicates that a ground fault has occurred. The wiring between the energy generation means and the Inverter remains energized with electrical potential.

This invention enhances the protection afforded by the Ground Fault Protection Devices and particularly for installations susceptible to tilt or tip-over, reduces the length of the system wiring that remains energized when the tilt protection detects unacceptable degree of tilt.

### OBJECTS OF THE INVENTION

It is an object of the present invention to provide an improved safety of energy generation installations where possibility of dangerous tilt or tip-over exists.

Another object is to provide a novel use of tilt sensors or tilt switches and electrical disconnect means in energy generation installations.

A further object it to provide separation between energy generation means and the structural elements of the supporting structure resulting reducing danger of electrical hazard.

These and other objects will become apparent when reading the following specification in conjunction with the accompanying drawings.

### BRIEF DESCRIPTION OF THE DRAWINGS

FIG. 1 is the block diagram of the energy generation system with tilt detection,

FIG. 2 is the block diagram as in FIG. 1 with addition of the grid voltage sensing,

FIG. 3 is the block diagram as in FIG. 2 with addition of the status indicator,

FIG. 4 is the block diagram as in FIG. 3 with addition of remote status communication;

FIG. 5A is the drawing of a canopy structure, such as for a photovoltaic system.

FIG. 5B is the drawing of a canopy structure as in 5a showing different axes of rotation.

FIG. 6 is the drawing of tilt control circuit as implemented in a photovoltaic system.

FIG. 7 is the drawing of tilt control circuit as in FIG. 6 with addition of status indicator.

FIG. 8 is the drawing of tilt control circuit for multiple canopy installation.

### DETAILED DESCRIPTION OF THE PREFERRED EMBODIMENT

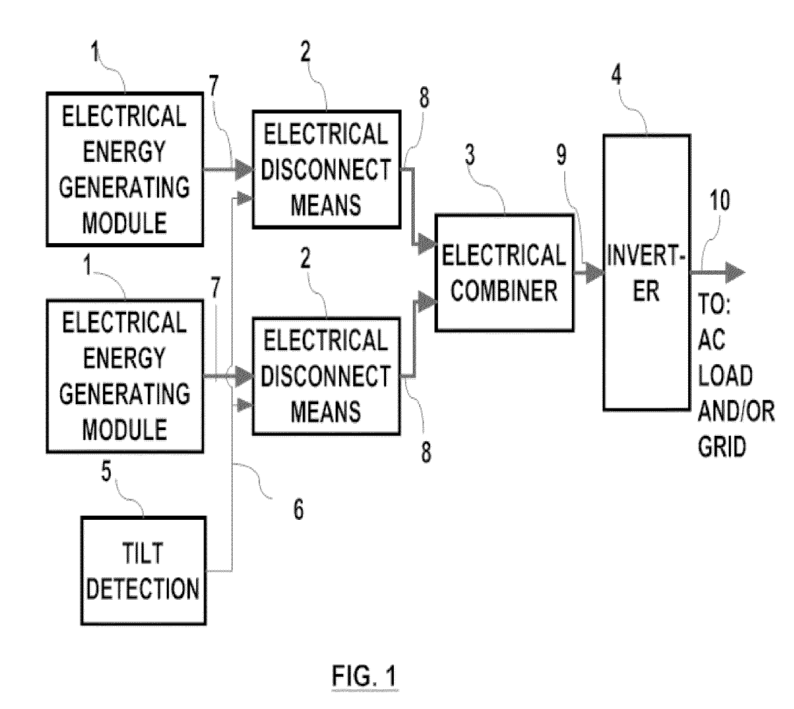

Referring to FIG. 1, an electrical energy generation system is represented in a block diagram form, A plurality of electrical energy generation modules 1 is connected through wiring 7 to electrical disconnect means 2, and through further wiring 8 to an electrical combiner 3. The output of the combiner 3 is connected to the inverter 4 through wiring 9. The AC output of the inverter is connected to power grid through wiring 10. The electrical disconnect means 2 are controlled by a tilt detection device 5 through wiring 6. There can be one or many energy generating modules 1 connected according to FIG. 1. The electrical disconnect means 2 can take a form of electrical relays or solid state relays. The tilt detection 5 can use two-axis tilt switch or (two) single axis tilt switches or an accelerometer with digital signal processing capability and ability to generate the control signal to the electrical disconnect means 2. The simplest form of tilt detection could use a mercury tilt switch such as described in U.S. Pat. No. 4,797,519. However, other types of switches exist that do not use environmentally dangerous elements such as mercury. There are numerous U.S. patents describing different types of tilt switches, one of the more recent ones involving a rolling ball and interrupting a light path is described in U.S. Pat. No. 7,485,818. Similar mechanical tilt sensors are described in U.S. Pat. No. 7,434,323 and in U.S. Pat. No. 7,421,793. It will be appreciated by those skilled in the art that other types of tilt sensing devices such as described in U.S. Pat. No. 7,254,897 producing an electrical signal that indicates the degree of tilt can used in this embodiment by providing a processor that interprets the tilt signal and sends control signal 6 to close or open the electrical disconnect means. In cases where in addition to tilt a vibration of the structure is required, an accelerometer and a processor can implement the tilt detection 5 function.

The electrical combiner 3 is typically used to connect separate energy generating modules 1 into single electrical wiring path 9. The wiring 9 carries the high current at the full system voltage to the inverter 4. In systems with standard Ground Fault Protection the wiring 9 remains energized, while the Inverter shuts down and does not supply AC current to the load or grid 10. The electrical disconnect means 2 implemented using an electromechanical relay or solid state relay remove the electrical potential from wiring 8 electrical combiner 3 and wiring 9 shutting down the inverter 4. The wiring 7 remains energized as it is directly connected to the electrical energy generation means 1. The reduced electrical path that remains energized during a dangerous tilt reduces the risk of exposure of high current carrying wiring to the elements of the structure that could come in contact with personnel.

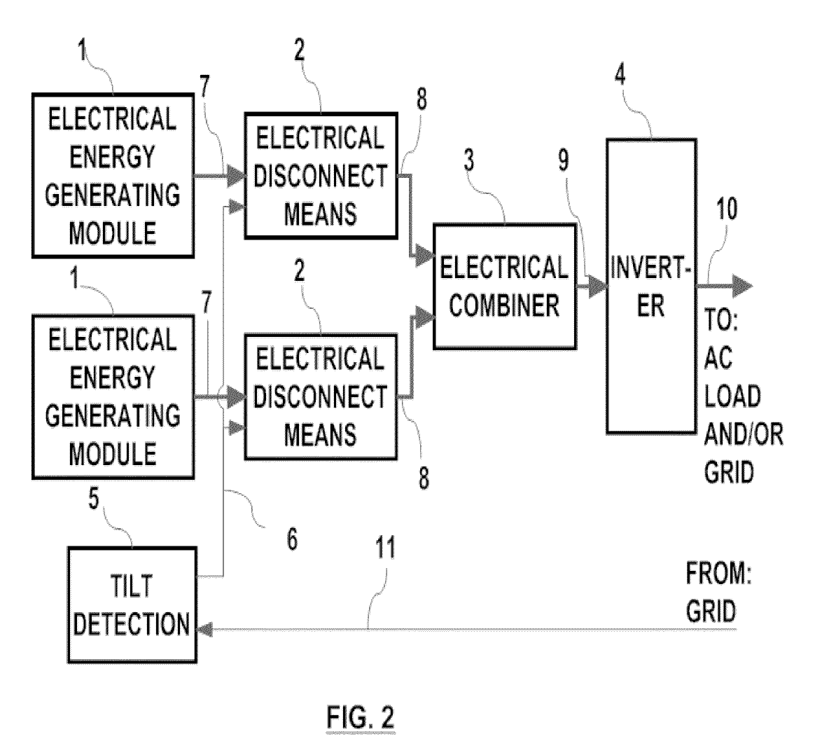

FIG. 2 shows an additional function of the tilt detection circuit 5. The tilt detection circuit 5 when powered by or when controlled by the presence of the grid voltage acts as an additional protection against supplying electrical to the grid in cases when the grid power is lost. The UL 1741 Standard requires that the inverter 4 shuts down when grid power is not present. This inventions provides for a back up to the inverter grid power detection circuitry. In case of the loss of grid power the energy supplied to inverter 4 is cut off by the electrical disconnect means 2. Additionally as in FIG. 1 description the system components and wiring that remains energized is significantly reduced. The wiring 8, 9 and combiner 3 are not energized during loss of grid power. It will be appreciated by those skilled in the art that normally open relays are the best used as the electrical disconnect means 2, since a presence of control signal 6 is required for the energy to flow from wiring 7 to wiring 8.

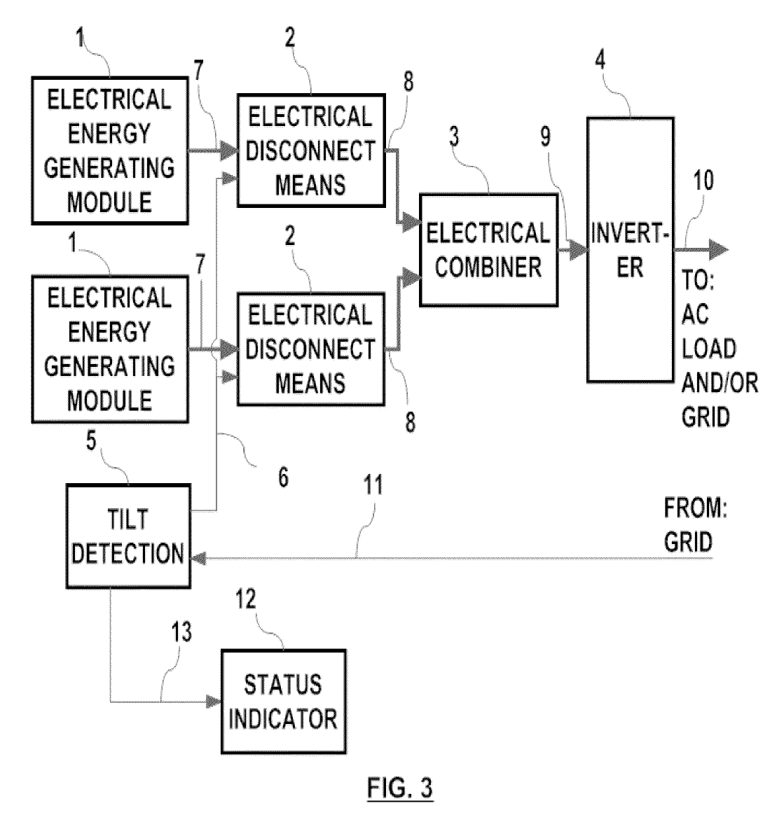

FIG. 3. describes a further enhancement of the system, by introducing a status indicator 12 connected to the tilt detection 5 with wire 13. The status indicator 12 can be implemented using LED or a lamp. When the status indicator 12 is lit the system operates normally and electrical energy should be flowing through wiring 8 combiner 3 wiring 9 to the inverter. When the energy is flowing to the inverter and there is no structural tilt present and the status indicator 12 is not lit, it indicates that the tilt detection 5 falsely shut off the energy. It will appreciated by those skilled in the art that if multiple tilt detection 5 circuits are used in a series to protect a long structure with many combiners 3 and electrical energy generating modules 1, the status indicators 12 will allow quick visual isolation of the faulty tilt detection 5.

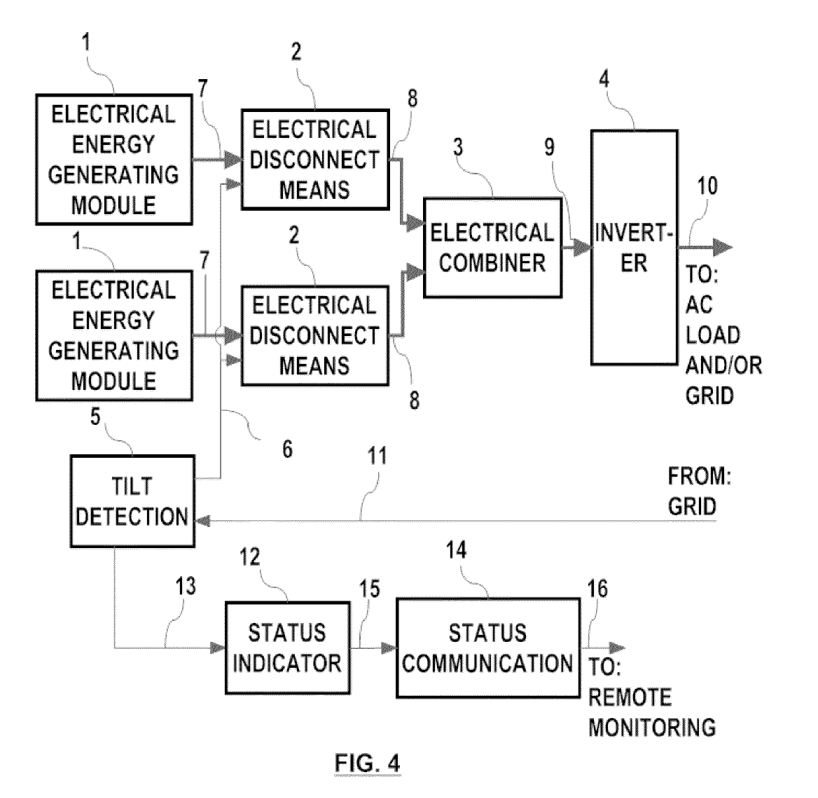

FIG. 4 expands the system described in FIG. 3 by including status communication 14 circuitry connected to status indicator 12 by wiring 15 and connected to remote monitoring by wiring 16. The status communication 14 circuitry includes a processor with data communication capability to send the state of the status indicator 12 to a remote monitoring site using available communication protocol over Local Area Network or Wide Area Network.

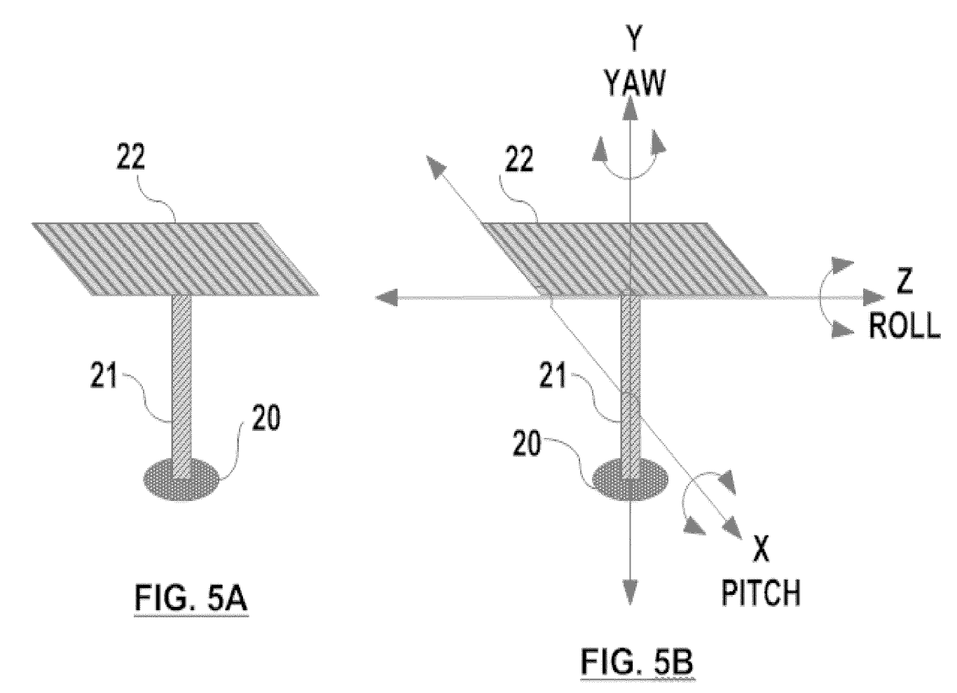

FIG. 5A describes one possible structure where canopy 22 is supported by a post 21 anchored to foundation 20. Referring to component numbers from FIG. 1-4 the electrical energy generation means 1 are mounted on the canopy 22. The electrical disconnect means 2, the electrical combiner 3 the tilt detection 5 and the corresponding wiring 6, 7, 8 are located under the canopy 22. In a typical installation the inverter 4 will be located on the ground and wiring 9 is guided through an appropriate enclosure from the combiner 3 mounted underneath canopy 22 to the inverter 4.

FIG. 5B describes different axes of rotation of the structure. The Pitch and Roll are the 2 primary axes of concern where the structure may reach a dangerous level or tilt. Rotation around Yaw axes could lead to twisting and breaking of the post 20, leading to further rotation around Pitch or Roll or both axes triggering the tilt detection circuit.

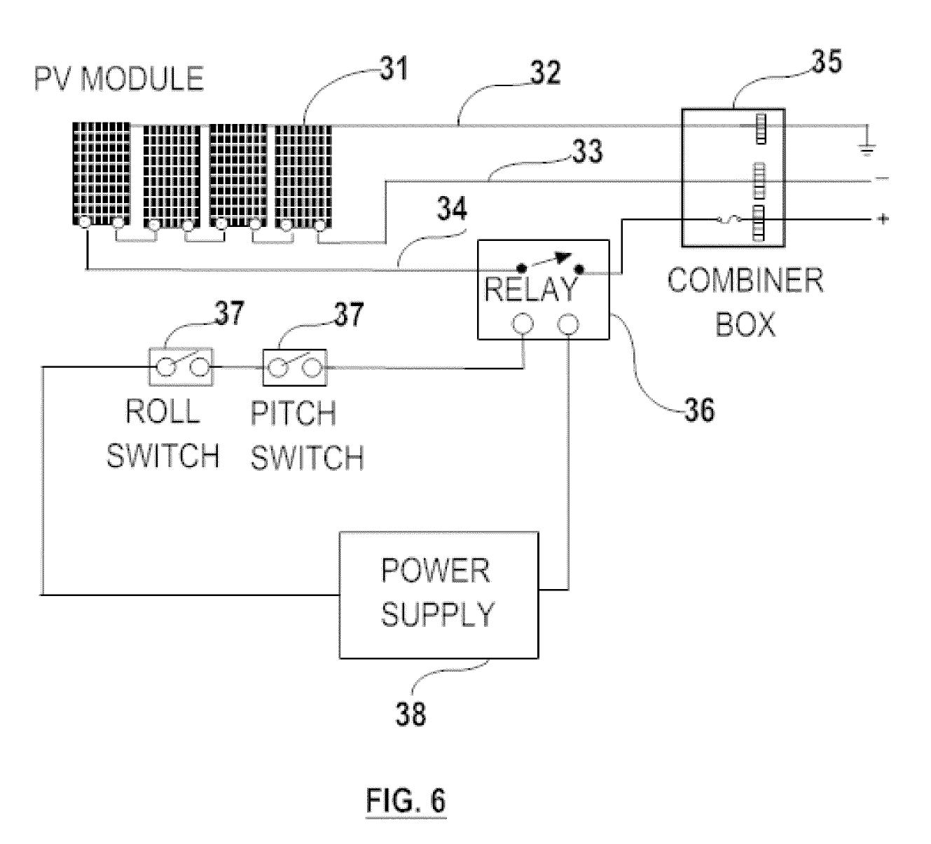

FIG. 6 describes the specific installation of the tilt detection circuit for a photovoltaic system. The tilt detection is comprised of two tilt switches 37 wired in series and mounted orthogonally to each other to detect pitch and roll of the structure. The tilt switches are connected in series with the control circuit of the relay 36 and with the power supply 38. It will be appreciated by those skilled in the art that relay 36 should be of the normally open type to insure that lack of current in the control circuit of the relay 36 opens the high current circuit. The general energy generation means 1 referred to in FIG. 1 through 4 is specifically represented here as photovoltaic modules 31. The photovoltaic modules 31 comprise the power circuit that includes the positive lead 34, the power contacts of the relay 36 the combiner 35, negative lead 33 and the grounding lead 32.

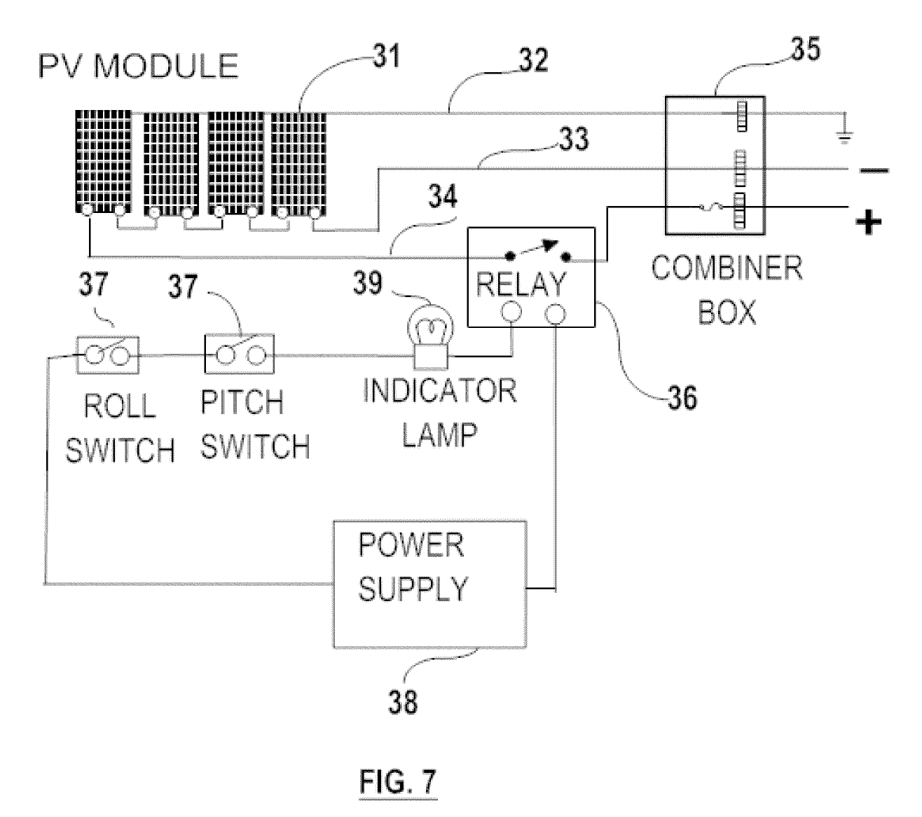

FIG. 7 describes the specific installation of the tilt detection circuit for a photovoltaic system with addition of the status indicator 39. The tilt detection is comprised of two tilt switches 37 wired in series and mounted orthogonally to each other to detect pitch and roll of the structure. The tilt switches are connected in series with the indicator lamp 39 and the control circuit of the relay 36 and with the power supply 38. The use of the indicator light helps diagnose system condition in cases where the power circuit is open, but the control lamp is on. In such case the power circuit is open for reasons other than structural tilt condition.

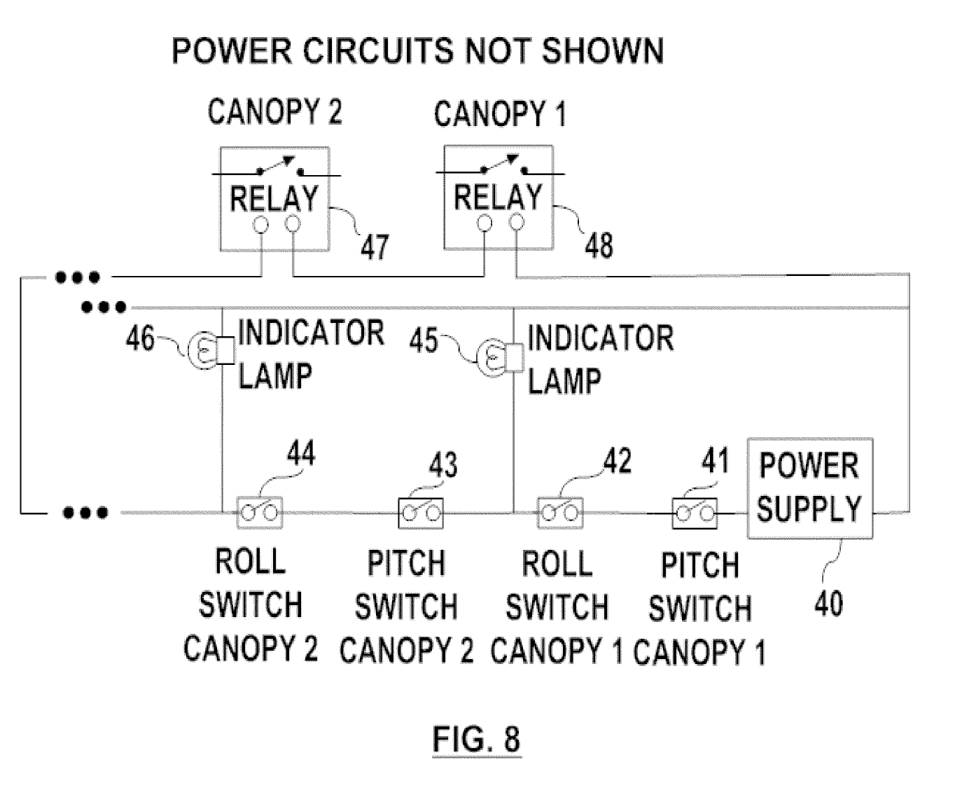

It will be appreciated by those skilled in the art that in installations where multiple canopies are connected in series the status indicator lights further enhance the ability to locate the tilt triggered disconnect condition. Refer to FIG. 8 describing tilt protection system for installation with more multiple canopies connected in analogous way as two canopies shown therein.

The power supply 40 is connected in series to pitch switch for first canopy 41 and subsequently to roll switch for first canopy 42 and subsequently to pitch switch for second canopy 43 and subsequently to roll switch for second canopy 44, additional switches for additional canopies are indicated by three dots. Following the string of tilt switches the control circuits of the relays are wired in series, as shown relay for second canopy 47 and relay for first canopy 48. Any additional canopy relays will be wired ahead of relay 47. The indicator lamps are wired in parallel after each pair of canopy tilt switches. The indicator lamp 45 is wired after the pitch switch 41 and roll switch 42 for first canopy. The indicator lamp 46 is wired after the pitch switch 43 and roll switch 44 for second canopy. The indicator lamps now allow for visual identification of the first canopy structure that triggered tilt condition. For example if the second canopy is tilted all power circuit are shut off, however the indicator lamp 45 will remain lit, the indicator lamp 46 and all subsequent indicator lights will be off, indicating that either switch 43 or switch 44 or both are open.

It will be appreciated by those skilled in the art that in addition to indicator lights a digital sensor can be connected to a processor providing remote tilt status indication as described in FIG. 4.

What is claimed is:

1. In an electrical energy generation installation such as but not limited to photovoltaic installation on raised structural support, and were such support is susceptible to a degree of tilt, and where such tilt may result in exposing the electrically energized components, an improved protection against exposure to dangerous electrical potential comprising:
a. means for detecting dangerous level of tilt of the structure
b. means of disconnecting the electrically energized components

2. Improvement according to claim 1, wherein, means of detection of dangerous tilt of the structure include a tilt sensor.

3. Improvement according to claim 1, wherein, means of detection of dangerous tilt of the structure include tilt switch.

4. Improvement according to claim 1, wherein, means of detection of dangerous tilt of the structure include an accelerometer and signal processing means.

5. Improvement according to claim 1, wherein, means of disconnecting energized components include an electromechanical relay.

6. Improvement according to claim 1, wherein, means of disconnecting energized components include a solid-state relay.

7. In an electrical energy generation installation such as but not limited to photovoltaic installation on raised structural support, and were such support is susceptible to a degree of tilt, and where such tilt may result in exposing the electrically energized components, an improved protection against exposure to dangerous electrical potential, which includes means of indicating status.

8. Improvement according to claim 7, wherein, means of indicating status include an LED indicator.

9. In an electrical energy generation installation such as but not limited to photovoltaic installation on raised structural support, and were such support is susceptible to a degree of tilt, and where such tilt may result in exposing the electrically energized components, an improved protection against exposure to dangerous electrical potential, which includes means of indicating and remotely communicating the status.

10. Improvement according to claim 9, wherein means of indicating and remotely communicating the status include a microcontroller with electronic communication capability.

11. Improvement according to claim 9, wherein means of indicating and remotely communicating the status include a microcontroller with electronic communication capability connected to a Local Area Network.

12. Improvement according to claim 9, wherein means of indicating and remotely communicating the status include a microcontroller with electronic communication capability connected to a Wide Area Network or Internet.

13. Improvement according to claim 9, wherein means of indicating and remotely communicating the status include a microcontroller with electronic communication capability connected to an on-site indicator panel.
